(19) United States
(12) Patent Application Publication
(10) Pub. No.: US 2012/0197635 A1
(43) Pub. Date: Aug. 2, 2012

(54) METHOD FOR GENERATING AN AUDIO SIGNAL

(75) Inventor: Martin NYSTRÖM, Horja (SE)

(73) Assignee: SONY ERICSSON MOBILE COMMUNICATIONS AB, Lund (SE)

(21) Appl. No.: 13/344,047

(22) Filed: Jan. 5, 2012

Related U.S. Application Data
(60) Provisional application No. 61/437,125, filed on Jan. 28, 2011.

(30) Foreign Application Priority Data
Jan. 28, 2011 (EP) 11 000 709.3

(51) Int. Cl. G10L 19/00

(52) U.S. Cl. 704/201; 704/E19.001

(57) ABSTRACT

A method for generating an audio signal of a user is provided. According to the method, a first audio signal inside of an ear of the user and a second audio signal outside of the ear is detected. The first audio signal and the second audio signal comprise at least a voice signal component generated by the user. Depending on the first audio signal the second audio signal is processed and output as the audio signal.

The present invention relates to a method for generating an audio signal and an audio device adapted to perform the method for generating the audio signal. The present invention relates especially to a method for generating an audio signal based on a voice signal component generated by a user.

### BACKGROUND OF THE INVENTION

In many electronic device, for example mobile phones, mobile digital assistants, mobile voice recorders and mobile navigation systems, audio signals comprising a voice signal of a user are detected and transmitted to another user, recorded or processed by for example a voice recognition system for extracting information from the voice signal. However, when the audio signal comprising the voice signal is detected, environmental noise may be present degrading the voice signal and especially the intelligibility of the voice signal. Therefore, noise cancelling for the detected audio signal comprising the voice signal before sending, recording or processing the voice signal is very important.

Several techniques for noise cancelling are available. For example, noise filtering techniques are known reducing frequency components outside a frequency range of human voice signals. Another approach for gaining an audio signal with reduced environmental noise is to detect the audio signal comprising the voice signal with a so called in-ear microphone inside an ear of the user. Inside the ear of the user the attenuation of environmental noise is very good inside the closed ear canal, but the quality of the voice signal taken from the in-ear microphone is so low that it is not adequate for use in the above-mentioned devices.

Therefore, it is an object of the present invention to provide a noise cancelling technique for audio signals comprising a voice signal generated by a user.

### SUMMARY OF THE INVENTION

According to the present invention, a first audio signal comprising at least a voice signal component generated by a user is detected. The voice signal component of the first audio signal is not received via acoustic waves emitted from the mouth of the user. Rather, the first audio signal may comprise an audio signal transmitted inside of the user from the vocal chords to the ear canal and may be detected in an ear of the user, or the first audio signal may be detected by detecting a vibration at a bone or the throat of the user due to a voice component generated by the user. A second audio signal comprising a voice signal component generated by the user is detected outside of the user via acoustic waves emitted from the user. The second audio signal is processed depending on the first audio signal, and the processed second audio signal is output as the audio signal. Although the first audio signal may not provide a high intelligibility, it may provide characteristics of the voice signal component generated by the user, for example a volume or a frequency range, which may be advantageously used for processing the second audio signal. Thus, by combining the first audio signal and the second audio signal, a good balance between audio quality and noise attenuation can be achieved.

According to an aspect of the present invention, a method for generating an audio signal is provided. According to the method, a first audio signal is detected inside of an ear of a user and a second audio signal is detected outside of the ear of the user. The first audio signal comprises at least a voice signal component generated by the user and the second audio signal comprises also at least a voice signal component generated by the user. Furthermore, according to the method, the second audio signal is processed depending on the first audio signal, and the processed second audio signal is output as the audio signal. Although the first audio signal detected inside the ear of the user does not provide a high intelligibility, it may provide characteristics of the voice signal component generated by the user, for example a volume or a frequency range, which may be advantageously used for processing the second audio signal detected outside the ear of the user. Thus, by combining the first audio signal detected inside the ear of the user and the second audio signal detected outside of the ear of the user, a good balance between audio quality and noise attenuation can be achieved.

According to an embodiment a third audio signal is reproduced in the ear of the user and the first audio signal is filtered depending on the third audio signal. When using a headset, the third audio signal may be an audio signal to be output to the user via a loudspeaker of the headset. The third audio signal may influence the first audio signal detected inside the ear of the user. Therefore, by filtering the first audio signal based on the third audio signal this influence may be avoided and the first audio signal may comprise essentially the voice signal components generated by the user.

According to a further aspect of the present invention, a further method for generating an audio signal is provided. According to the method, a first audio signal is detected by detecting a vibration of a body part of a user, and a second audio signal is detected by detecting an air vibration outside of the body of the user. The first audio signal comprises at least a voice signal component generated by the user and the second audio signal comprises also at least a voice signal component generated by the user. Furthermore, according to the method, the second audio signal is processed depending on the first audio signal, and the processed second audio signal is output as the audio signal. Although the first audio signal comprising the vibration at the body part, e.g. a cheek bone or the throat of the user, may not provide a high intelligibility, it may provide characteristics of the voice signal component generated by the user, for example a volume or a frequency range, which may be advantageously used for processing the second audio signal detected via air vibrations or air waves emitted from the mouth of the user. Thus, by combining the first audio signal detected as vibration and the second audio signal detected as air waves, a good balance between audio quality and noise attenuation can be achieved.

According to an embodiment the method is performed using a mobile device, for example a mobile phone, a mobile digital assistant, a mobile voice recorder, or a mobile navigation system. The mobile device may comprise for example a headset comprising an in-ear audio output unit and an audio input unit for receiving audio signals in an area outside the head of the user between the ear and the mouth of the user. The in-ear audio output unit may comprise a loudspeaker for reproducing audio signals to the user and may comprise additionally a microphone for receiving the first audio signal inside the ear of the user, wherein the first audio signal comprises a voice signal component generated by the user. As an alternative, the in-ear output unit may comprise an electroacoustic transducer which is adapted to output an audio signal and receive an audio signal at the same time. Thus, the headset of the mobile device may be used to detect the first audio signal inside the ear and the second audio signal outside of the ear. For detecting the vibration, a bone conductive microphone attached to a cheek bone of the user or a throat microphone attached with e.g. a rubber band to the throat of the user may be used. The bone conducting microphone or the throat microphone may be adapted to detect vibrations by detecting an acceleration of the body part they are attached to. The first audio signal and the second audio signal may be detected simultaneously and processed by a processing unit of the mobile device.

According to another embodiment, the step of processing the second audio signal comprises a gating of the second audio signal depending on the first audio signal. Gating the second audio signal depending on the first audio signal may be formed by switching the second audio signal on and off depending on the volume of the first audio signal. By controlling when the second audio signal is output depending on the first audio signal, much noise can be removed from the output audio signal.

According to a further embodiment of the method, a frequency characteristic of the first audio signal is determined and a frequency mask depending on the frequency characteristic is determined. The second audio signal is processed by filtering the second audio signal based on the frequency mask. For example, a frequency range of the first audio signal may be determined and a lowest frequency of the first audio signal may be determined from the frequency range. Then, frequency components of the second audio signal having a lower frequency than the lowest frequency of the first audio signal may be suppressed. By filtering the second audio signal based on the frequency mask of the first audio signal before outputting the second audio signal a good noise suppression can be achieved when the user is speaking. Furthermore, vowels in the first audio signal may be determined and depending on which vowel is spoken by the user a suitable frequency pattern or frequency mask may be used to filter the second audio signal before outputting the second audio signal.

According to another aspect of the present invention, an audio device is provided. The audio device comprises an in-ear audio detecting unit adapted to detected a first audio signal in an ear of a user, an outer audio detecting unit adapted to detect a second audio signal outside of the ear of the user, and a processing unit. The first audio signal comprises at least a voice signal component generated by the user and the second audio signal comprises at least a voice signal component generated by the user. The processing unit is coupled to the in-ear audio detecting unit and the outer audio detecting unit. The processing unit is adapted to process the second audio signal depending on the first audio signal and to output the processed second audio signal as an audio signal of the user.

According to an embodiment, the audio device comprises a headset comprising an in-ear part or an in-ear unit to be inserted into the ear of the user and an outer microphone which may be arranged in an area outside the head of the user between the ear and the mouth of the user. The in-ear part of the headset comprises a microphone acting as the in-ear audio detecting unit. The outer microphone of the headset acts as the outer audio detecting unit. This headset enables an easy way to detect the first audio signal in the ear of the user and the second audio signal outside of the ear of the user.

According to another embodiment, the audio device comprises a headset comprising an earspeaker adapted to be inserted into the ear of the user and an outer microphone which may be arranged in an area outside of the user between the ear and the mouth of the user. The earspeaker is adapted to reproduce a third audio signal which is to be output to the user and to detect the first audio signal in the ear of the user. Thus, the earspeaker is acting as a bi-directional electroacoustic transducer for outputting the third audio signal and receiving the first audio signal. By using the earspeaker of a traditional headset, for example a dynamic earspeaker, also as in-ear microphone an extra or additional in-ear microphone is not necessary which may reduce the size of the unit to be inserted into the ear of the user.

The audio device may be adapted to perform the above-described method and may comprise therefore the above-described advantages.

According to a further aspect of the present invention, a further audio device is provided. The audio device comprises a first audio detecting unit adapted to detected a vibration of a body part of a user as a first audio signal, a second audio detecting unit adapted to detect an air vibration or air waves outside of the body of the user as a second audio signal, and a processing unit. The first audio signal comprises at least a voice signal component generated by the user and the second audio signal comprises at least a voice signal component generated by the user. The processing unit is coupled to the first audio detecting unit and the second audio detecting unit. The processing unit is adapted to process the second audio signal depending on the first audio signal and to output the processed second audio signal as an audio signal of the user.

According to another aspect of the present invention a mobile device is provided. The mobile device comprises the audio device as defined above. The mobile device may be adapted to transmit the processed second audio signal as the user's audio signal via a telecommunication network. Furthermore, the mobile device may comprise for example a mobile phone, a mobile digital assistant, a mobile voice recorder or a mobile navigation system.

Although specific features described in the above summary and the following detailed description are described in connection with specific embodiments, it is to be understood that the features of the embodiments may be combined with each other unless noted otherwise.

### BRIEF DESCRIPTION OF THE DRAWINGS

The invention will now be described in more detail with reference to the accompanying drawings.

FIG. 1 shows schematically a user and a mobile device according to an embodiment of the present invention.

FIG. 2 shows schematically a user and a mobile device according to another embodiment of the present invention.

### DETAILED DESCRIPTION OF PREFERRED EMBODIMENTS

In the following, exemplary embodiments of the present invention will be described in more detail. It has to be understood that the following description is given only for the purpose of illustrating the principles of the invention and it is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise. Same reference signs in the various instances of the drawings refer to similar or identical components.

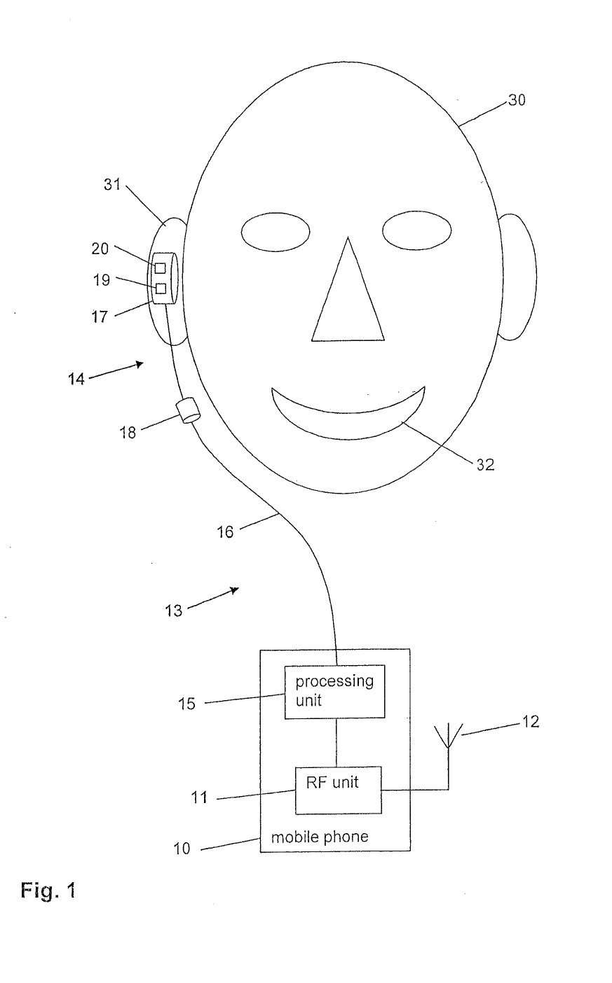

FIG. 1 schematically shows a mobile device 10, for example a mobile phone, and a user 30. The mobile device 10 comprises a radio frequency unit 11 (RF unit) and an antenna 12 for communicating data, especially audio data, via a mobile communication network (not shown). The mobile phone 10 comprises furthermore an audio device 13 comprising a headset 14, a processing unit 15, and a wire 16 connecting the headset 14 to the processing unit 15. Instead of the wire 16 there may be provided a wireless connection between the headset 14 and the processing unit 15. The headset 14 comprises an in-ear unit 17 adapted to be inserted into an ear 31 of the user 30. The headset 14 comprises furthermore a microphone 18 adapted to be arranged in an area between the ear 31 and a mouth 32 of the user 30. The in-ear unit 17 comprises a further microphone 19 and a loudspeaker 20.

When the user 30 is remotely communicating with another person via the mobile phone 10, the user 30 may utter a voice signal to be transmitted to the other person. However, when the user 30 is speaking, there may be environmental noise which may deteriorate the intelligibility of the voice signal generated by the user 30. Therefore, a first audio signal is captured or detected via the microphone 19 of the in-ear unit 17. Furthermore a second audio signal is simultaneously captured or detected outside of the ear 31 of the user 30 via the microphone 18. Both, the first audio signal and the second audio signal, are transmitted to the processing unit 15 which processes the second audio signal depending on the first audio signal and taking into account the following considerations: the in-ear microphone 19 gives a signal that is not satisfactory for voice. However, the in-ear microphone 19 is a very accurate indicator for indicating when the user is talking and a fairly good indicator indicating the kind of sound the user creates. Therefore, the processing 15 combines the good audio quality from the outer microphone 18 with noise reducing filtering based on the first audio signal from the in-ear microphone 19.

For example, the first audio signal from the in-ear microphone 19 may be used to control when sound is sent from the outer microphone 18 by standard gating methods. Therefore, much noise can be removed from the second audio signal before the second audio signal is sent to the other person, especially during a speech pause. Furthermore, the first audio signal from the in-ear microphone 19 may be used to control characteristics of the second audio signal from the outer microphone 18. This may achieve a good noise suppression when the user 30 is speaking. In more detail, the first audio signal from the in-ear microphone 19 is analyzed. For example, a frequency content of the first audio signal is determined and based on this information the second audio signal from the outer microphone 18 is processed. For example, there may be no need to send lower frequencies from the outer microphone 18 than the frequencies of the first audio signal detected by the in-ear microphone 19. Therefore, these lower frequencies may be cut before transmitting the second audio signal to the other person. Furthermore, although the audio quality from the in-ear microphone 19 is poor, it may be still possible to determine which vowel is actually spoken. Depending on which vowel is spoken, a frequency pattern or frequency mask may be provided to pass the voice signal component of the second audio signal from the outer microphone 18 while attenuating other sounds and surrounding noise. The frequency filtering may be combined with the gating. By this combination of audio signals from the in-ear microphone 19 and the outer microphone 18, a good balance between audio quality and noise attenuation can be achieved.

Via the loudspeaker 20 of the in-ear unit 17 a third audio signal may be output from the mobile phone 10 to the user 30. The third audio signal may comprise for example voice data of the other person the user 30 is talking to. The third audio signal may be used for filtering the first audio signal received by the in-ear microphone 19 before the first audio signal is used for processing the second audio signal.

Furthermore, a dynamic earspeaker may be used in the in-ear unit 17 to replace the in-ear microphone 19 and the loudspeaker 20. In combination with an appropriate detecting technique the dynamic earspeaker may be used as speaker and microphone in a full duplex mode. Thus, the in-ear microphone 19 is not necessary which may reduce the size and the cost of the in-ear unit 17. The appropriate detecting technique for the full duplex mode my be realized by software of the processing unit 15.

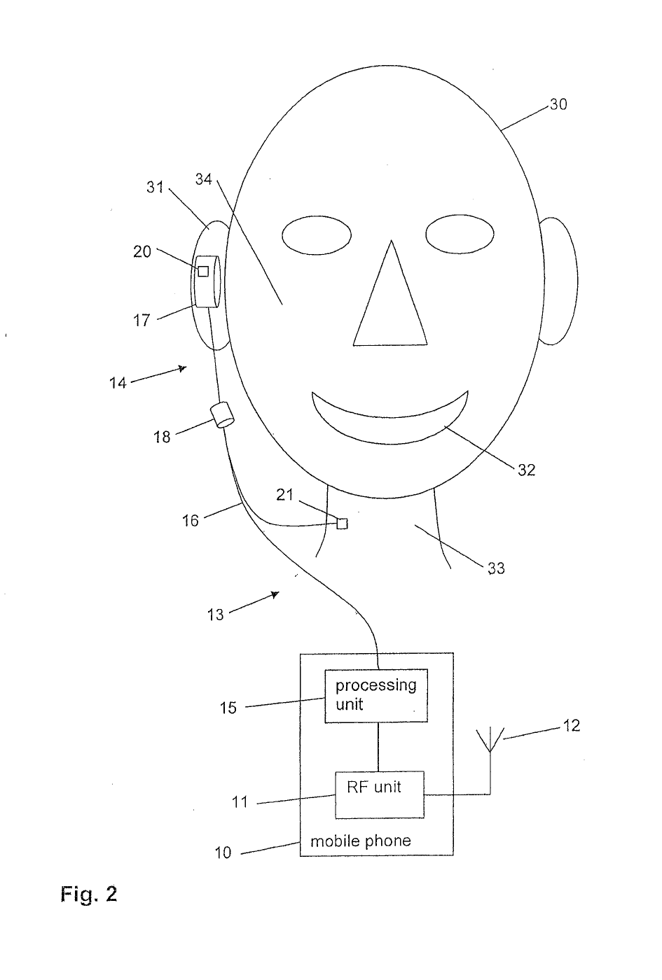

FIG. 2 schematically shows a further embodiment of a mobile device 10. Instead of the microphone 19 of the in-ear unit 17 of the mobile device 10 of FIG. 1, the mobile device 10 of FIG. 2 comprises a vibration detection unit 21 coupled to the processing unit 15. The remaining components of the mobile device 10 of FIG. 2 correspond to the components of the mobile device 10 of FIG. 1 and will therefore not be explained again.

The vibration detection unit 21 may be attached to a body part of the user 30. For example, the vibration detection unit 21 may be attached to a cheek bone 34 of the user 30 or, as shown in FIG. 2, to the throat 33 of the user 30. The vibration detection unit 21 may comprise a throat microphone or a bone conducting microphone adapted to detect a vibration of the body part, e.g. by measuring an acceleration of the body part. The vibration detection unit 21 may be adapted to detect a first audio signal as vibrations from the body part when the user is speaking. Thus, the first audio signal comprises a voice signal component generated by the user. Furthermore a second audio signal is simultaneously captured or detected via air vibrations or air waves emitted from the mouth of the user 30 via the microphone 18. Both, the first audio signal and the second audio signal, are transmitted to the processing unit 15 which processes the second audio signal depending on the first audio signal and taking into account the following considerations: the vibration detection unit 21 gives a signal that is not satisfactory for voice. However, as the vibration detection unit 21 detects structural sounds instead of air waves, the first audio signal may be very clean from surrounding noise and may be a very accurate indicator for indicating when the user is talking and a fairly good indicator indicating the kind of sound the user creates. Therefore, the processing 15 combines the good audio quality from the outer microphone 18 with noise reducing filtering based on the first audio signal from the vibration detection unit 21, as described in connection with FIG. 1 above.

While exemplary embodiments have been described above, various modifications may be implemented in other embodiments. For example, the above-described gating and filtering of the second audio signal may be combined with existing noise suppressing methods for single microphone applications. Furthermore, it is to be understood that all the embodiments described above are considered to be comprised by the present invention as it is defined by the appended claims.

1. A method for generating an audio signal, comprising the steps of:
detecting a first audio signal inside of an ear of a user, the first audio signal comprising at least a voice signal component generated by the user,
detecting a second audio signal outside of the ear of the user, the second audio signal comprising at least a voice signal component generated by the user,
processing the second audio signal depending on the first audio signal, and
outputting the processed second audio signal as the audio signal.

2. The method according to claim 1, further comprising the step of reproducing a third audio signal in the ear of the user and filtering the first audio signal depending on the third audio signal.

3. A method for generating an audio signal, comprising the steps of:
detecting a first audio signal by detecting a vibration of a body part of a user, the first audio signal comprising at least a voice signal component generated by the user,
detecting a second audio signal by detecting an air vibration outside of the body of the user, the second audio signal comprising at least a voice signal component generated by the user,
processing the second audio signal depending on the first audio signal, and
outputting the processed second audio signal as the audio signal.

4. The method according to claim 3, wherein detecting the first audio signal comprises detecting the vibration at a cheek or a throat of the user.

5. The method according to claim 1, wherein the method is performed using a mobile device comprising at least one of the group comprising a mobile phone, a mobile digital assistant, a mobile voice recorder, and a mobile navigation system.

6. The method according to claim 1, wherein the step of detecting the second audio signal comprises detecting the second audio signal in an area outside the head of the user between the ear and the mouth of the user.

7. The method according to claim 1, wherein the steps of detecting the first audio signal and detecting the second audio signal are performed simultaneously.

8. The method according to claim 1, wherein the step of processing the second audio signal comprises gating the second audio signal depending on the first audio signal.

9. The method according to claim 1, further comprising the steps:
determining a frequency characteristic of the first audio signal, and
determining a frequency mask depending on the frequency characteristic, wherein the step of processing the second audio signal comprises filtering the second audio signal based on the frequency mask.

10. The method according to claim 9, wherein the step of determining the frequency characteristic of the first audio signal comprises determining a vowel in the first audio signal.

11. The method according to claim 1, further comprising the step of determining a minimum frequency of the first audio signal, wherein the step of processing the second audio signal comprises removing frequency components lower than the minimum frequency from the second audio signal.

12. An audio device, comprising:
an in-ear audio detecting unit adapted to detect a first audio signal in an ear of a user, the first audio signal comprising at least a voice signal component generated by the user,
an outer audio detecting unit adapted to detect a second audio signal outside of the ear of the user, the second audio signal comprising at least a voice signal component generated by the user, and
a processing unit coupled to the in-ear audio detecting unit and the outer audio detecting unit, the processing unit being adapted to process the second audio signal depending on the first audio signal and to output the processed second audio signal as an audio signal of the user.

13. The audio device according to claim 12, wherein the audio device comprises a headset, wherein the in-ear audio detecting unit comprises a microphone of an in-ear part of the headset adapted to be inserted into the ear of the user, and wherein the outer audio detecting unit comprises an outer microphone of the headset.

14. The audio device according to claim 12, wherein the audio device comprises a headset, wherein the in-ear audio detecting unit comprises an ear speaker adapted to be inserted into the ear of the user and adapted to reproduce a third audio signal to the user and to detect the first audio signal in the ear of the user, and wherein the outer audio detecting unit comprises an outer microphone of the headset.

15. The audio device according to claim 12, wherein the audio device is adapted to perform the method according to claim 1.

16. An audio device, comprising:
a first audio detecting unit adapted to detect a vibration of a body part of a user as a first audio signal, the first audio signal comprising at least a voice signal component generated by the user,
a second audio detecting unit adapted to detect an air vibration outside of the body of the user as a second audio signal, the second audio signal comprising at least a voice signal component generated by the user, and
a processing unit coupled to the first audio detecting unit and the second audio detecting unit, the processing unit being adapted to process the second audio signal depending on the first audio signal and to output the processed second audio signal as an audio signal of the user.

17. The audio device according to claim 16, wherein the audio device is adapted to perform the method according to claim 1.

18. A mobile device comprising the audio device according to claim 12.

19. The mobile device according to claim 18, wherein the mobile device is adapted to transmit the processed second audio signal as the user's audio signal via a telecommunication network.

20. The mobile device according to claim 18, wherein the mobile device comprises at least one of the group comprising a mobile phone, a mobile digital assistant, a mobile voice recorder, and a mobile navigation system.
